(19) United States
(12) Patent Application Publication
(10) Pub. No.: US 2026/0110984 A1
(43) Pub. Date: Apr. 23, 2026

(54) IMAGE FORMING APPARATUS

(71) Applicant: KYOCERA Document Solutions Inc., Osaka (JP)

(72) Inventors: Takafumi Shibuya, Osaka (JP); Keiju Ishida, Osaka (JP)

(21) Appl. No.: 19/359,474

(22) Filed: Oct. 15, 2025

(30) Foreign Application Priority Data
Oct. 18, 2024 (JP) 2024-182491

(51) Int. Cl. G03G 15/20; G03G 21/20

(52) U.S. Cl. CPC G03G 15/2053; G03G 15/2064; G03G 21/206; G03G 2215/2025

(57) ABSTRACT

A fusing unit includes an opposing surface that is opposite to a portion of a heating unit and is formed in a first direction. A heating unit includes an adhesion surface and an elastic seal member. An adhesion surface is opposite to the opposing surface and is formed in the first direction. A seal member is arranged with the first direction as a longitudinal direction, is adhered to the adhesion surface, and is sandwiched between the opposing surface and the adhesion surface when the heating unit is located at a proximity position. The seal member has a structure in which a first foam member adhered to the adhesion surface, a resin sheet adhered to the first foam member, and a second foam member adhered to the resin sheet are stacked.

### INCORPORATION BY REFERENCE

This application is based upon and claims the benefit of priority from the corresponding Japanese Patent Application No. 2024-182491 filed on Oct. 18, 2024, the entire contents of which are incorporated herein by reference.

### BACKGROUND

The present disclosure relates to an image forming apparatus including a fusing apparatus divided into a fusing unit and a heating unit.

An electrophotographic image forming apparatus transfers a toner image onto a sheet from an image carrier and fuses the toner image on the sheet through a fusing apparatus.

The fusing apparatus may be divided into a heating unit including a heater and a fusing unit including a fusing member and a pressure roller. The heater heats the fusing member and the pressure roller biases the sheet with the toner image transferred thereon to the fusing member.

Moreover, it is known that the fusing apparatus includes a mechanism that moves the heating unit between a proximity position along the fusing unit and a retreat position more distant from the fusing unit than the proximity position.

### SUMMARY

An image forming apparatus according to an aspect of the present disclosure includes a transfer apparatus, a fusing apparatus, and a unit moving mechanism that moves a portion of the fusing apparatus. The transfer apparatus transfers a toner image formed on an image carrier onto a sheet. The fusing apparatus fuses the toner image to the sheet by heating and pressing the toner image on the sheet. The fusing apparatus includes a fusing unit and a heating unit. The fusing apparatus includes a fusing member to be heated and a pressure member and is arranged with a first direction as a longitudinal direction, the pressure member biasing the sheet with the toner image formed thereon to the fusing member. The heating unit includes a heater that heats the fusing member and is arranged with the first direction as the longitudinal direction, next to the fusing unit in a second direction that intersects with the first direction. The unit moving mechanism is a mechanism that moves the heating unit between a proximity position along the fusing unit and a retreat position more distant from the fusing unit than the proximity position. The fusing unit includes an opposing surface that is opposite to a portion of the heating unit and is formed in the first direction. The heating unit includes an adhesion surface and an elastic seal member. The adhesion surface is opposite to the opposing surface and is formed in the first direction. The seal member is arranged with the first direction as the longitudinal direction, is adhered to the adhesion surface, and is sandwiched between the opposing surface and the adhesion surface when the heating unit is located at the proximity position. The seal member has a structure in which a first foam member adhered to the adhesion surface, a resin sheet adhered to the first foam member, and a second foam member adhered to the resin sheet are stacked.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF FIGURES

FIG. 1 is a configuration view of an image forming apparatus according to an embodiment.

FIG. 2 is a configuration view of a portion of a fusing apparatus in the image forming apparatus according to the embodiment.

FIG. 3 is a front view of a fusing apparatus in a proximity state in the image forming apparatus according to the embodiment.

FIG. 4 is a front view of the fusing apparatus in a separated state in the image forming apparatus according to the embodiment.

FIG. 5 is a plan view of the fusing apparatus in the proximity state and a unit moving mechanism in the image forming apparatus according to the embodiment.

FIG. 6 is a plan view of the fusing apparatus in the separated state and the unit moving mechanism in the image forming apparatus according to the embodiment.

FIG. 7 is a plan view of a coupling mechanism of a unit coupling member when the unit moving mechanism in the image forming apparatus according to the embodiment is in a biased state.

FIG. 8 is a plan view of the coupling mechanism of the unit coupling member when the unit moving mechanism in the image forming apparatus according to the embodiment is in a pulled state.

FIG. 9 is a plan cross-sectional view of a peripheral portion of a seal member in the image forming apparatus according to the embodiment.

FIG. 10 is a perspective view of the seal member in the image forming apparatus according to the embodiment.

FIG. 11 is a plan cross-sectional view of a peripheral portion of a seal member according to a modified example that can be applied to the image forming apparatus according to the embodiment.

FIG. 12 is a front view of a fusing apparatus according to a modified example that can be applied to the image forming apparatus according to the embodiment.

### DETAILED DESCRIPTION

Embodiments of the present disclosure will be described below with reference to the drawings. Note that the following embodiments are merely examples embodying the present disclosure and do not limit the technical scope of the present disclosure.

### Configuration of Image Forming Apparatus 10

An image forming apparatus 10 according to an embodiment performs print processing by an electrophotographic method. The print processing is processing of forming an image on each of sheets 900.

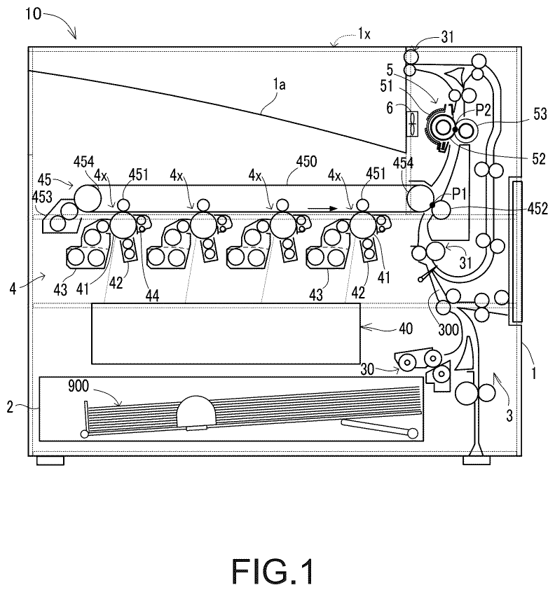

As shown in FIG. 1, the image forming apparatus 10 includes a sheet accommodation part 2, a sheet conveyance apparatus 3, and a print apparatus 4. The sheet conveyance apparatus 3 and the print apparatus 4 are housed in a main body 1 that is a casing. The main body 1 includes a main body frame 1x that forms the framework of the main body 1 and exterior members attached to the main frame 1x.

The sheet conveyance apparatus 3 includes a sheet feed apparatus 30 and a plurality of conveyance roller pairs 31. The sheet feed apparatus 30 feeds the sheet 900 in the sheet accommodation part 2 to a conveyance path 300 one by one. The conveyance path 300 is a passageway for the sheet 900.

The plurality of conveyance roller pairs 31 conveys the sheet 900 along the conveyance path 300. One pair of the plurality of conveyance roller pairs 31 outputs the sheet 900 with the image formed thereon to an output tray 1a from the conveyance path 300.

The print apparatus 4 performs the above-mentioned print processing on the sheet 900 conveyed along the conveyance path 300. The image formed on the sheet 900 is a toner image.

The print apparatus 4 includes a light scan unit 40, one or more image forming parts 4x, a transfer apparatus 45, and a fusing apparatus 5. Each of the image forming parts 4x includes a photoreceptor 41, a charging apparatus 42, a developing apparatus 43, and a drum cleaning apparatus 44.

The charging apparatus 42 charges the surface of the photoreceptor 41. The light scan unit 40 scans the charged surface of the photoreceptor 41 with beam light. Accordingly, the light scan unit 40 forms an electrostatic latent image on the surface of the photoreceptor 41.

The developing apparatus 43 develops the electrostatic latent image to be a toner image by supplying toner to the surface of the photoreceptor 41. The transfer apparatus 45 transfers the toner image formed on the surface of the photoreceptor 41 onto the sheet 900.

The transfer apparatus 45 transfers the toner image formed on the photoreceptor 41 onto the sheet 900. The transfer apparatus 45 transfers the toner image onto the sheet 900 at a transfer position P1 on the conveyance path 300. The photoreceptor 41 is an example of an image carrier that rotates, carrying the toner image.

In the present embodiment, the print apparatus 4 is a tandem-type color print apparatus with a plurality of image forming parts 4x. Moreover, the transfer apparatus 45 includes an intermediate transfer belt 450, a plurality of primary transfer apparatuses 451, a secondary transfer apparatus 452, and a belt cleaning apparatus 453.

In the example shown in FIG. 1, the print apparatus 4 includes four image forming parts 4x corresponding to toner four toner colors: yellow, magenta, cyan, and black. The transfer apparatus 45 includes four primary transfer apparatuses 451 corresponding to the four image forming parts 4x.

The intermediate transfer belt 450 is rotatably supported by a plurality of support rollers 454. One of the plurality of the support rollers 454 is rotated by being driven by a belt drive apparatus (not shown). This rotates the intermediate transfer belt 450.

The primary transfer apparatuses 451 each transfers the toner image formed on the surface of the photoreceptor 41 in each of the image forming parts 4x onto the surface of the intermediate transfer belt 450. This forms a toner image combining toner images of four colors on the surface of the intermediate transfer belt 450.

The intermediate transfer belt 450 rotates, carrying the toner image. The secondary transfer apparatus 452 transfers the toner image formed on the surface of the intermediate transfer belt 450 onto the sheet 900 at the transfer position P1.

The drum cleaning apparatus 44 removes primary waste toner from the surface of the photoreceptor 41. The primary waste toner is toner that remains on a portion of the surface of the photoreceptor 41 after passing through the primary transfer apparatuses 451.

The belt cleaning apparatus 453 removes the secondary waste toner from the surface of the intermediate transfer belt 450. The secondary waste toner is toner that remains on a portion of the surface of the intermediate transfer belt 450 after passing through the secondary transfer apparatus 452.

The fusing apparatus 5 heats and presses the toner image on the sheet 900 at a fusing position P2 on the conveyance path 300. Accordingly, the fusing apparatus 5 fuses the toner image on the sheet 900. The fusing position P2 is a position downstream in a sheet conveyance direction with respect to the transfer position P1.

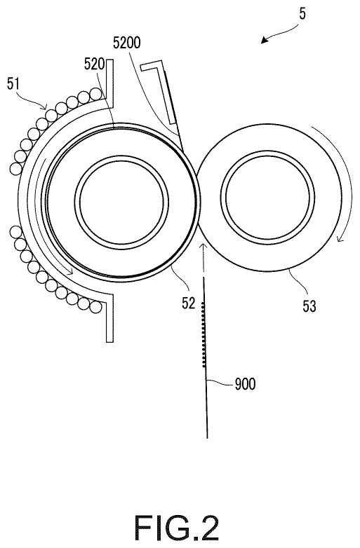

As shown in FIG. 2, the fusing apparatus 5 includes a heater 51, a fusing belt 52, a fusing roller 520, a pressure roller 53, and a sheet separation member 5200.

The fusing belt 52 is a flexible cylindrical member that encases the fusing roller 520. The fusing belt 52 is heated by the heater 51.

The fusing roller 520 is a cylindrical member that supports the fusing belt 52 within the fusing roller 520 itself. The fusing roller 520 is rotatably supported. The fusing belt 52 is rotatable with the fusing roller 520.

The fusing belt 52 includes a conductive base material, an elastic layer formed at the outer periphery of the base material, and a release layer formed at the outer periphery of the elastic layer.

The heater 51 is arranged to be opposite to the outer circumferential surface of the fusing belt 52 and heats the fusing belt 52. In the present embodiment, the heater 51 is an electromagnetic induction heating apparatus. The heater 51 mainly heats the base material of the fusing belt 52 by electromagnetic induction. It should be noted that for example, a halogen heater may be employed as the heater 51.

The pressure roller 53 is rotatably supported. The pressure roller 53 is driven by a drive apparatus (not shown) to rotate. The fusing belt 52 and the fusing roller 520 rotate in conjunction with the pressure roller 53.

The fusing belt 52 heats the toner image formed on the sheet 900. The pressure roller 53 presses the toner image toward the sheet 900 by biasing the sheet 900 to the fusing belt 52.

It should be noted that the fusing belt 52 is an example of a fusing member 51 to be heated by the heater. The pressure roller 53 is an example of a pressure member that biases the fusing belt 52 to the sheet 900.

The sheet separation member 5200 peels the sheet 900 from the fusing belt 52 when the sheet 900 sticks to the fusing belt 52.

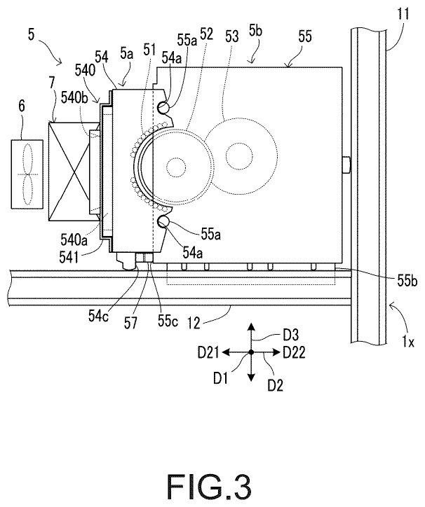

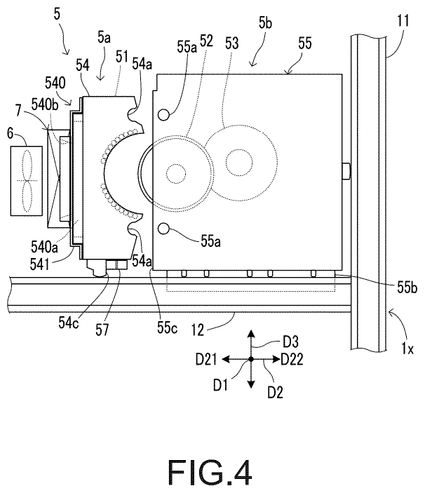

In the present embodiment, the fusing apparatus 5 is divided into a heating unit 5a and a fusing unit 5b (see FIGS. 3 and 4). The heating unit 5a is arranged in a first direction D1 in the main body 1. The fusing unit 5b is also arranged in the first direction D1 in the main body 1.

That is, the heating unit 5a and the fusing unit 5b are each arranged with the first direction D1 as a longitudinal direction.

The heating unit 5a is arranged next to the fusing unit 5b in a second direction D2. That is, the second direction D2 is a direction in which the heating unit 5a and the fusing unit 5b are arranged. The second direction D2 is a direction orthogonal to the first direction D1.

Hereinafter, one side in the second direction D2 will be referred to as a first side D21 and the other side in the second direction D2 will be referred to as a second side D22 (see FIGS. 3 to 10). The heating unit 5a is arranged on the first side D21 with respect to the fusing unit 5b (see FIGS. 3 to 6).

The heating unit 5a includes the heater 51 and a first support 54. The fusing unit 5b includes the fusing belt 52, the fusing roller 520, the pressure roller 53, and a second support 55.

The first support 54 is a member that supports the heater 51. The second support 55 is a member that supports the fusing belt 52, the fusing roller 520, and the pressure roller 53. The fusing belt 52 is supported by the second support 55 via the fusing roller 520.

The main body frame 1x includes a plurality of metal pipes joined by welding, for example. The heating unit 5a and the fusing unit 5b are supported by the main body frame 1x.

The plurality of metal pipes in the main body frame 1x includes regulating portions 11 and lower supporting portions 12 (see FIGS. 3 to 6).

In the present embodiment, the regulating portions 11 are two support pipes that are formed to extend in a vertical direction D3 and arranged with a distance therebetween in the first direction D1 (see FIGS. 3 and 4). The vertical direction D3 is upper and lower directions.

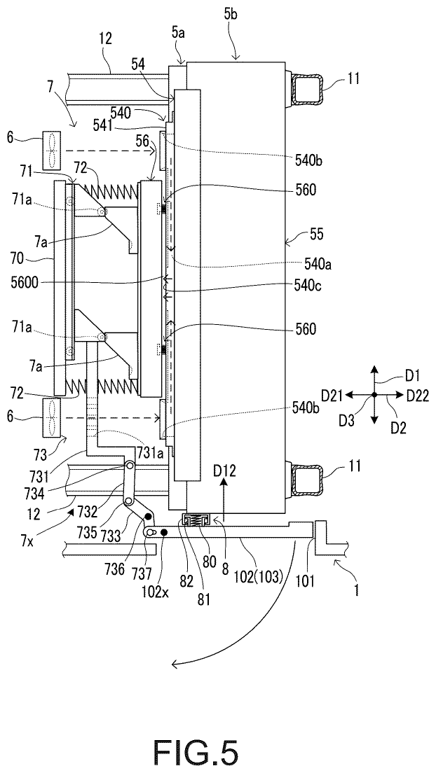

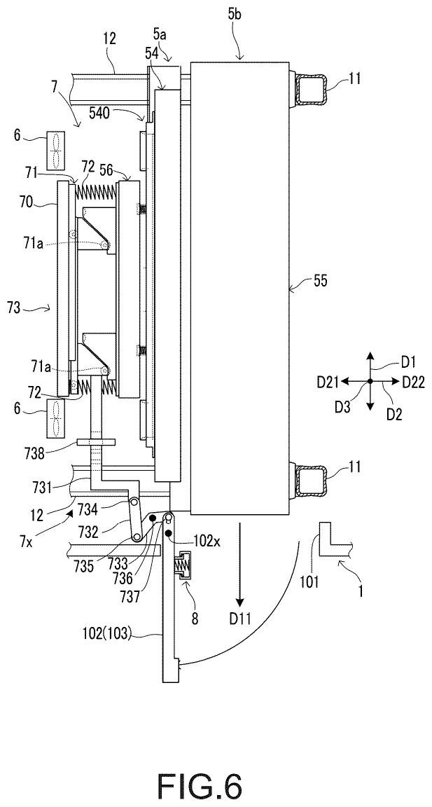

The lower supporting portions 12 are two beam pipes that are formed to extend in the second direction D2 below the heating unit 5a and the fusing unit 5b and arranged with a distance therebetween in the first direction D1 (see FIGS. 5 and 6).

The heating unit 5a and the fusing unit 5b are each placed on the lower supporting portions 12 in a state in which the longitudinal direction is in the first direction D1 (see FIGS. 3 and 4).

The heating unit 5a is movable on the lower supporting portions 12 in the second direction D2. Specifically, the heating unit 5a is movable between the proximity position along the fusing unit 5b and a retreat position more distant from the fusing unit 5b to the first side D21 than the proximity position. The fusing unit 5b is arranged between the heating unit 5a and the regulating portions 11 (see FIGS. 4 and 5).

When the heating unit 5a is located at the retreat position, the fusing unit 5b can be pulled out of the main body 1 in the first direction D1 (see FIG. 6).

The main body 1 has an exposed opening 101 that exposes the interior to the outside (see FIGS. 5 and 6). The fusing unit 5b is arranged in the first direction D1 inside the exposed opening 101 in the main body 1.

The exposed opening 101 is an opening that opens one end of the fusing unit 5b in the first direction D1 to the outside of the main body 1. The image forming apparatus 10 includes a cover member 102 capable of opening and closing the exposed opening 101 (see FIGS. 5 and 6).

The cover member 102 is rotatable around a first support axis 102x between a close position for closing the exposed opening 101 and an open position for opening the exposed opening 101. FIG. 5 shows the cover member 102 and the fusing apparatus 5 located at the close position. FIG. 6 shows the cover member 102 and the fusing apparatus 5 located at the open position.

When the cover member 102 is located at the close position, the cover member 102 is retained at the close position by a lock mechanism (not shown). By releasing the lock by the locking mechanism, the cover member 102 is rotatable from the close position to the open position.

When the heating unit 5a is located at the retreat position and the cover member 102 is located at the open position, the fusing unit 5b can be pulled out of the main body 1 through the exposed opening 101. In FIG. 6, a pulling direction D11 is a direction in which the fusing unit 5b is pulled out of the main body 1.

The image forming apparatus 10 includes the unit moving mechanism 7 that moves the heating unit 5a between the proximity position and the retreat position (see FIGS. 5 and 6). The unit moving mechanism 7 is arranged on the first side D21 in the second direction D2 with respect to the heating unit 5a.

In addition, the image forming apparatus 10 includes one or more fans 6 that blow air toward the heating unit 5a (see FIGS. 1 and 3 to 6). The fans 6 are arranged on the first side D21 in the second direction D2 with respect to the unit moving mechanism 7 inside the main body 1 (see FIGS. 3 to 6).

In the present embodiment, the image forming apparatus 10 includes a pair of fans 6 arranged with a distance therebetween in the first direction D1 (see FIGS. 5 and 6).

The heating unit 5a includes a ventilation duct 540 that exchanges heat between the heater 51 and the cooling air by passing cooling air blown from the pair of fans 6 (see FIGS. 3 to 6).

### Configuration of Unit Moving Mechanism 7 and Ventilation Duct 540

The cover member 102 also serves as an operation member 103 that is coupled with the unit moving mechanism 7 and receives an operation to operate the unit moving mechanism 7 (see FIGS. 5 and 6).

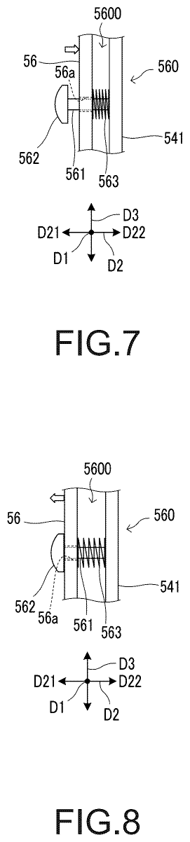

The cover member 102 is movable in a first operation direction or a second operation direction by being operated. The cover member 102 is arranged at one end of the main body 1 in the first direction D1 (see FIGS. 7 and 8).

Hereinafter, the direction in which the cover member 102 moves from the open position to the close position will be referred to as a first operation direction. Also, the direction in which the cover member 102 moves from the close position to the open position will be referred to as a second operation direction.

The unit moving mechanism 7 moves the heating unit 5a in the second direction D2 in conjunction with the movement of the cover member 102.

The unit moving mechanism 7 moves the heating unit 5a from the retreat position to the proximity position in conjunction with the movement of the cover member 102 in the first operation direction (see FIG. 5). On the other hand, the unit moving mechanism 7 moves the heating unit 5a from the proximity position to the retreat position in conjunction with the movement of the cover member 102 in the second operation direction (see FIG. 6).

The unit moving mechanism 7 includes a unit coupling member 56 and a link mechanism 7x. The unit coupling member 56 is coupled with the heating unit 5a. The link mechanism 7x transmits the motion of the cover member 102 to the unit coupling member 56.

The heating unit 5a further includes a duct forming member 541 that is attached to a surface of the first support 54 on the first side D21 (see FIGS. 3 to 6). In the present embodiment, the ventilation duct 540 is constituted by the duct forming member 541 and the first support 54.

The ventilation duct 540 includes a cavity part 540a formed between the first support 54 and the duct forming member 541, a pair of inlet openings 540b in communication with the cavity part 540a, and an outlet opening 540c in communication with the cavity part 540a (see FIG. 5). The pair of inlet openings 540b and the outlet opening 540c are openings formed in the duct forming member 541.

The cavity part 540a is formed in the first direction D1 (see FIG. 5). That is, the cavity part 540a is formed along the heater 51 with the first direction D1 as the longitudinal direction.

The pair of inlet openings 540b is arranged at a position to be opposite to the pair of fans 6. The pair of fans 6 and the pair of inlet openings 540b are arranged both outwardly in the first direction D1 with respect to the unit coupling member 56.

The pair of fans 6 blows air toward the second side D22 in the second direction D2. The pair of inlet openings 540b is opened to the first side D21 in the second direction D2 at positions corresponding to the pair of fans 6 in the first direction D1.

The outlet opening 540c is formed between the pair of inlet openings 540b in the first direction D1. In the present embodiment, the outlet opening 540c is opened on the first side D21 in the second direction D2.

The unit coupling member 56 is coupled to the heating unit 5a at a position between the pair of inlet openings 540b in the first direction D1 and the outlet opening 540c with a gap 5600 therebetween (see FIG. 7). The outlet opening 540c is opened toward the gap 5600.

In the present embodiment, the unit coupling member 56 is coupled to the duct forming member 541 of the heating unit 5a through a coupling mechanism 560 (see FIGS. 5, 7, and 8).

The cooling air fed by the pair of fans 6 flows in the cavity part 540a through the pair of inlet openings 540b. In addition, the cooling air efficiently cools the heating unit 5a in the process of flowing in the cavity part 540a from both end portions in the first direction D1 toward the center of the first direction D1.

In addition, the cooling air flows out of the cavity part 540a to the gap 5600 through the outlet opening 540c after cooling the heating unit 5a. The cooling air flows out of the gap 5600 mainly in the vertical direction D3.

The link mechanism 7x includes a guide member 70, a movable member 71, first biasing members 72, and a first direction moving mechanism 73.

The first biasing members 72 bias the heating unit 5a to the first side D21. Specifically, the first biasing members 72 are one or more elastic members that bias the heating unit 5a to the first side D21. For example, the elastic member is a coil spring or a plate spring, for example.

In the example shown in FIGS. 5 and 6, the first biasing members 72 are two tensile springs that elastically bias the heating unit 5a toward the first side D21.

The unit coupling member 56 has an inclined surface 7a. The inclined surface 7a is provided on the first side D21, facing the heating unit 5a. The inclined surface 7a is a surface inclined to the first side D21 from the second side D22 with respect to the first direction D1. In the present embodiment, the inclined surface 7a is provided at two positions spaced apart in the first direction D1 (see FIGS. 5 and 6).

The movable member 71 is supported to be movable in the first direction D1. The guide member 70 guides the movable member 71 in the first direction D1. For example, the guide member 70 is supported by the main body frame 1x.

The movable member 71 has one or more rollers 71a rotatably supported (see FIGS. 7 to 9). The rollers 71a are provided at positions corresponding to the inclined surface 7a in the movable member 71. In the present embodiment, the rollers 71a are provided at two positions spaced apart in the first direction D1 (see FIGS. 7 to 9). The rollers 71a roll in contact with the inclined surface 7a.

The first direction moving mechanism 73 moves the movable member 71 in the first direction D1 in conjunction with the movement of the cover member 102. In the present embodiment, the first direction moving mechanism 73 is a mechanism that converts the rotation of the cover member 102 into a linear motion in the first direction D1.

The first direction moving mechanism 73 includes a first link member 731, a second link member 732, and a third link member 733 (see FIGS. 7 and 8).

One end of the first link member 731 is connected to the movable member 71 and the other end of the first link member 731 is coupled to one end of the second link member 732 through a first coupling axis 734. The other end of the second link member 732 is connected to one end of the third link member 733 through a second coupling axis 735. The other end of the third link member 733 is coupled to one end of the cover member 102 through a third coupling axis 737.

The third link member 733 is rotatably supported by a second support axis 736.

The first direction moving mechanism 73 moves the movable member 71 to a deep side in the first direction D1 in conjunction with the movement of the cover member 102 in the first operation direction. Moreover, the first direction moving mechanism 73 moves the movable member 71 to a front side in the first direction D1 in conjunction with the movement of the cover member 102 in the second operation direction.

When the movable member 71 is interlocked with the movement of the cover member 102 in the first operation direction, the rollers 71a push the inclined surface 7a to the second side D22 while rolling on the inclined surface 7a. Accordingly, the unit moving mechanism 7 moves the heating unit 5a from the retreat position to the proximity position against biasing force of the first biasing members 72.

The regulating portions 11 regulate the movement range of the fusing unit 5b to the second side D22. By the rollers 71a moving the heating unit 5a to the second side D22, the fusing unit 5b and the heating unit 5a are sandwiched by the movable member 71 and the regulating portions 11 (see FIGS. 3 and 5).

FIG. 5 shows the unit moving mechanism 7 in a biased state in which the movable member 71 biases the heating unit 5a and the fusing unit 5b toward the regulating portions 11. FIGS. 3 and 5 show the fusing apparatus 5 in the proximity state in which the heating unit 5a is retained at the proximity position by the unit moving mechanism 7.

The fusing unit 5b and the heating unit 5a is positioned in the second direction D2 by being sandwiched by the movable member 71 and the regulating portions 11.

The first support 54 has a plurality of first fitting parts 54a in a recess shape opened on the second side D22 (see FIGS. 3 and 4). The second support 55 has a plurality of second fitting parts 55a in a concave shape in which the plurality of first fitting parts 54a can be fitted (see FIGS. 3 and 4).

By the unit moving mechanism 7 moving the heating unit 5a to the second side D22, the plurality of first fitting parts 54a and the plurality of second fitting parts 55a are fitted to each other (see FIG. 3).

The plurality of first fitting parts 54a and the plurality of second fitting parts 55a fitted to each other limit a relative movement of the heating unit 5a and the fusing unit 5b in the vertical direction D3.

It should be noted that the second support 55 may include the first fitting parts 54a and the first support 54 may include the second fitting parts 55a.

On the other hand, when the movable member 71 is interlocked with the movement of the cover member 102 in the second operation direction, the rollers 71a roll on the inclined surface 7a and the first biasing members 72 move the heating unit 5a to the first side D21.

FIG. 6 shows the unit moving mechanism 7 in a pulled state in which the first biasing members 72 are pulling the heating unit 5a to the first side D21. FIGS. 4 and 6 show the fusing apparatus 5 in a separated state in which the heating unit 5a is pulled away from the fusing unit 5b to the first side D21 by the unit moving mechanism 7. The separated state is a state in which the heating unit 5a is located at the retreat position.

The coupling mechanism 560 includes a shaft portion 561, an engaging portion 562, and a second biasing member 563 (see FIGS. 7 and 8).

The shaft portion 561 is formed to protrude from the heating unit 5a to the first side D21 in the second direction D2. In the present embodiment, a first end of the shaft portion 561 is fixed to the duct forming member 541.

The shaft portion 561 is inserted into a through hole 56a in the second direction D2, which is formed in the unit coupling member 56. The engaging portion 562 is formed at a second end of the shaft portion 561. The engaging portion 562 is larger than the inner diameter of the through hole 56a.

The engaging portion 562 engages an edge of the through hole 56a in the unit coupling member 56 when the unit coupling member 56 moves to the first side D21 in the second direction D2. This prevents the shaft portion 561 from exiting the through hole 56a.

The second biasing member 563 is arranged between the unit coupling member 56 and the heating unit 5a. Accordingly, the second biasing member 563 functions as a spacer that forms the gap 5600 between the unit coupling member 56 and the heating unit 5a.

In the present embodiment, the second biasing member 563 is arranged between the unit coupling member 56 and the duct forming member 541 and forms the gap 5600 between the unit coupling member 56 and the duct forming member 541.

When the unit moving mechanism 7 is in the biased state, the engagement with the unit coupling member 56 by the engaging portion 562 is cancelled, and the second biasing member 563 elastically biases the duct forming member 541 to the second side D22 while forming the gap 5600 (see FIG. 7). Accordingly, the heating unit 5a moves from the retreat position to the proximity position and is positioned at the proximity position.

On the other hand, when the unit moving mechanism 7 is in the pulled state, the engaging portion 562 engages the unit coupling member 56 and force of pulling the duct forming member 541 to the first side D21 in the second direction D2 acts on the duct forming member 541 from the shaft portion 561 (see FIG. 8). Accordingly, the heating unit 5a moves from the proximity position to the retreat position.

Moreover, the image forming apparatus 10 further includes a first direction biasing mechanism 8 attached to an inner surface of the cover member 102 (see FIGS. 5 and 6). Moreover, the second support 55 of the fusing unit 5b has a protrusion portion 55b that protrudes from a lower surface of the second support 55 (see FIGS. 3 and 4).

The first direction biasing mechanism 8 includes a spring 80, a spring case 81, and a cap portion 82 (see FIG. 7).

The spring case 81 houses the spring 80. The cap portion 82 is movably attached to the spring case 81. The spring 80 is an example of an elastic member.

The spring 80 is sandwiched between the cover member 102 and the second support 55 of the fusing unit 5b when the cover member 102 is located at the close position. In the present embodiment, the spring 80 and the cap portion 82 are sandwiched between the cover member 102 and the second support 55.

By being sandwiched between the cover member 102 and the second support 55, the spring 80 biases the second support 55 to a mounting direction D12 by elastic force (see FIG. 5). The mounting direction D12 is a direction opposite to a pulling direction D11 of the fusing unit 5b.

Moreover, the protrusion portion 55b comes into contact with the lower supporting portions 12 by force received by the second support 55 from the spring 80 when the cover member 102 is located at the close position.

The fusing unit 5b is positioned in the first direction D1 by the action of the spring 80 and the protrusion portion 55b. It should be noted that the first direction biasing mechanism 8 may be attached to the second support 55 of the fusing unit 5b.

The first link member 731 moves in the first direction D1 in conjunction with the motion of the cover member 102. The first link member 731 is arranged to extend in the first direction D1 from an end portion in the first direction D1 on a side where the cover member 102 is arranged in the main body 1 to a position opposite to the unit coupling member 56 (see FIGS. 5 and 6).

One or more ventilation openings 731a are formed in a portion of the first link member 731, which is located between one of the pair of fans 6 and one of the pair of inlet openings 540b (see FIG. 5). Air fed from the one of the pair of fans 6 smoothly flows through the ventilation openings 731a to the one of the pair of inlet openings 540b.

By the way, in the image forming apparatus 10, there is a risk that scattered toner may enter a space between the heating unit 5a and the fusing unit 5b. The intrusion of the scattered toner into the space between the heating unit 5a and the fusing unit 5b may cause noise images on the sheet 900.

In view of this, the fusing apparatus 5 includes a seal member 57 that fills the gap between the heating unit 5a and the fusing unit 5b (see FIGS. 3 and 4). However, it may not be possible to sufficiently narrow the gap between the heating unit 5a and the fusing unit 5b. In this case, it is necessary to employ the seal member 57 with a large thickness.

In a case where the thickness of the seal member 57 is large, the seal member 57 may bend when the heating unit 5a is brought closer to the heating unit 5a, resulting in a seal failure.

In the fusing apparatus 5, the seal member 57 has a structure that prevents a seal failure due to bending. Hereinafter, the structure will be described below.

The fusing unit 5b has an opposing surface 55c opposing a portion of the heating unit 5a. The heating unit 5a has an adhesion surface 54c opposing the opposing surface 55c (see FIGS. 3 and 4, 9). The adhesion surface 54c is a surface to which the seal member 57 is adhered.

In the present embodiment, the adhesion surface 54c is formed on the first support 54 of the heating unit 5a and the opposing surface 55c is formed on the second support 55 of the fusing unit 5b.

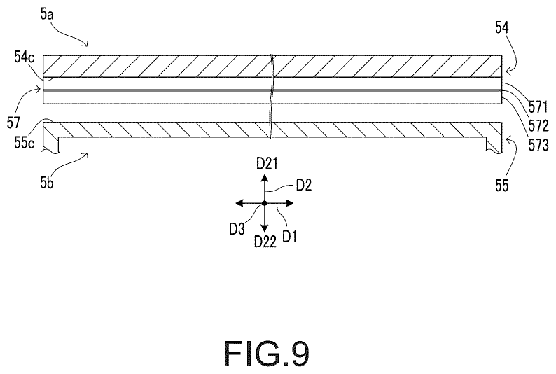

The opposing surface 55c and the adhesion surface 54c are each formed in the first direction D1 (see FIG. 9). In other words, the longitudinal direction of each of the opposing surface 55c and the adhesion surface 54c is the first direction D1.

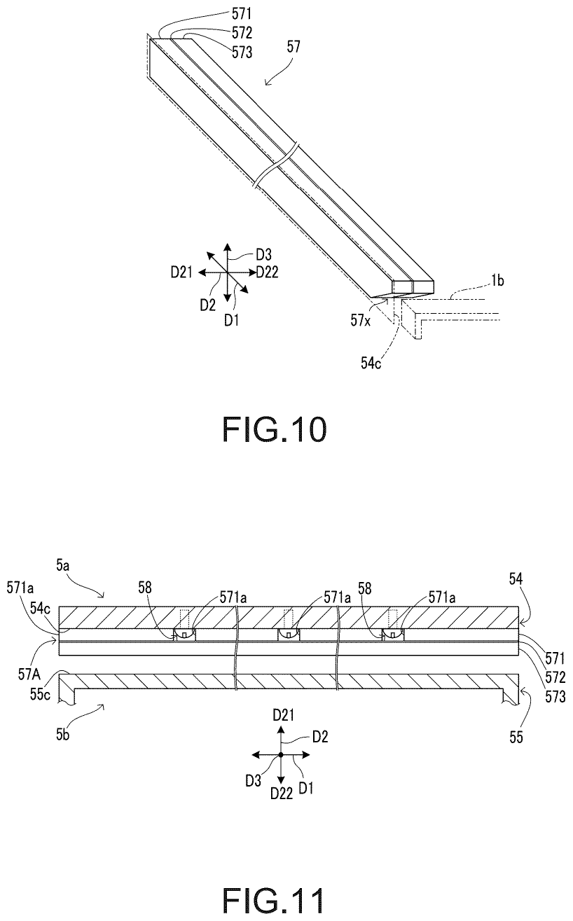

The seal member 57 is arranged with the first direction D1 as the longitudinal direction and is adhered to the adhesion surface 54c (see FIGS. 9 and 10). The seal member 57 is an elastic member, which is sandwiched between the opposing surface 55c and the adhesion surface 54c when the heating unit 5a is located at the proximity position (see FIG. 3).

The seal member 57 elastically contracts by being sandwiched between the opposing surface 55c and the adhesion surface 54c.

The seal member 57 has a structure in which a first foam member 571, a resin sheet 572, and a second foam member 573 are stacked (see FIGS. 9 and 10). The first foam member 571 is adhered to the adhesion surface 54c of the heating unit 5a. The resin sheet 572 is adhered to the first foam member 571. The second foam member 573 is adhered to the resin sheet 572.

In the present embodiment, the adhesion surface 54c, the first foam member 571, the resin sheet 572, and the second foam member 573 are adhered to one another by a plurality of double-sided tapes. It should be noted that the adhesion surface 54c, the first foam member 571, the resin sheet 572, and the second foam member 573 may be bonded by an adhesive.

For example, each of the first foam member 571 and the second foam member 573 is a foam of ethylene propylene rubber or a foam of urethane rubber. The resin sheet 572 is a polycarbonate sheet member or the like. Moreover, an acrylic sheet or the like may be employed as the resin sheet 572.

In the example shown in FIG. 10, a cutout 57x is formed at one end portions of the first foam member 571, the resin sheet 572, and the second foam member 573 in the first direction D1 (see FIG. 10). The cutout 57x is formed to avoid interference between a sheet metal member 1b, which forms part of the main body frame 1x, and the seal member 57.

In the present embodiment, the relatively small thickness of the first foam member 571 and the second foam member 573 make up the relatively large thickness of the seal member 57. The resin sheet 572 contributes to preventing the seal member 57 from bending without interfering with the elasticity of the seal member 57 in the thickness direction.

By employing the seal member 57, even when the distance between the opposing surface 55c and the adhesion surface 54c cannot be sufficiently narrowed, sealing defects caused by bending of the seal member 57 are less likely to occur.

In the example shown in FIGS. 3 and 4, the adhesion surface 54c is a surface at a lower edge of the first support 54, which is on the second side D22 in the second direction D2, and the opposing surface 55c is a surface at a lower edge of the second support 55, which is on the first side D21 in the second direction D2.

Between the heating unit 5a and the fusing unit 5b, the air is heated by the heater 51, which causes an upward air flow. Therefore, the scattered toner is less likely to enter the gap between an upper edge of the heating unit 5a and an upper edge of the fusing unit 5b, and more likely to enter the gap between the lower edge of the heating unit 5a and the lower edge of the fusing unit 5b.

In the present embodiment, the seal member 57 is arranged in the gap between the lower edge of the heating unit 5a and the lower edge of the fusing unit 5b, which the scattered toner easily enters.

Moreover, since the fans 6 blow air toward the heating unit 5a, the scattered toner is easily carried by the wind blown from the fans 6 to the gap between the heating unit 5a and the fusing unit 5b. The seal member 57 is remarkably effective in the fusing apparatus 5 that is cooled by the fans 6.

### First Modified Example

Next, a seal member 57A that is a modified example of the seal member 57 will be described with reference to FIG. 11.

The seal member 57A has a structure in which a first foam member 571, a resin sheet 572, and a second foam member 573 are stacked as in the seal member 57.

In the seal member 57A, the first foam member 571 is constituted by a plurality of unit foam members 571a arranged at intervals in the first direction D1. The plurality of unit foam members 571a is each arranged with the first direction D1 as the longitudinal direction and adhered to an adhesion surface 54c.

A heating unit 5a having the seal member 57A has one or more protrusions 58 that protrude on the adhesion surface 54c. The protrusions 58 are arranged between the plurality of unit foam members 571a on the adhesion surface 54c.

That is, the first foam member 571 of the seal member 57A is divided into the plurality of unit foam members 571a in order to avoid interference with the protrusions 58.

In the example shown in FIG. 11, the first foam member 571 is constituted by four unit foam members 571a and the heating unit 5a has the three protrusions 58. Moreover, each of the protrusions 58 is the head of a screw screwed to the adhesion surface 54c of the first support 54.

In the seal member 57A, the resin sheet 572 functions to couple and reinforce the plurality of unit foam members 571a. Also in a case where the seal member 57A is employed, a similar effect is obtained as in a case where the seal member 57 is employed.

### Second Modified Example

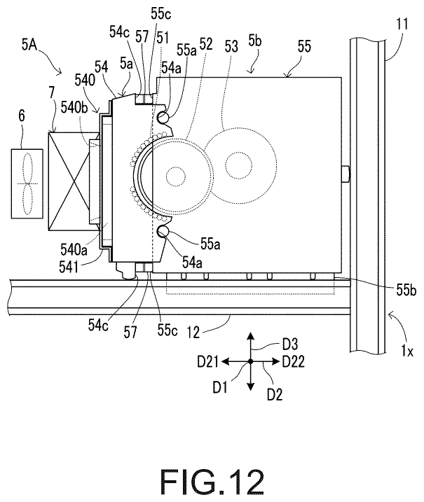

Next, a fusing apparatus 5A that is a modified example of the fusing apparatus 5 will be described with reference to FIG. 12.

In the fusing apparatus 5A, a heating unit 5a includes a pair of adhesion surfaces 54c at two positions, lower and upper edges of a first support 54, and a fusing unit 5b includes a pair of opposing surfaces 55c at two positions, lower and upper edges of a second support 55.

In addition, the fusing apparatus 5A includes a pair of seal members 57 adhered to the pair of adhesion surfaces 54c. Also in a case where the fusing apparatus 5A is employed, a similar effect is obtained as in a case where the fusing apparatus 5 is employed.

### Notes of Disclosure

The outline of the invention extracted from the above-mentioned embodiments will be given below. Note that the configurations and processing functions described in the following notes can be arbitrarily selected and combined.

### <Note 1>

An image forming apparatus, including:
a transfer apparatus that transfers a toner image formed on an image carrier onto a sheet;
a fusing apparatus that fuses the toner image to the sheet by heating and pressing the toner image on the sheet; and
a unit moving mechanism that moves a portion of the fusing apparatus, in which
the fusing apparatus includes
   a fusing unit that includes a fusing member to be heated and a pressure member and is arranged with a first direction as a longitudinal direction, the pressure member biasing the sheet with the toner image formed thereon to the fusing member, and
   a heating unit that includes a heater that heats the fusing member and is arranged with the first direction as the longitudinal direction, next to the fusing unit in a second direction that intersects with the first direction,
the unit moving mechanism is a mechanism that moves the heating unit between a proximity position along the fusing unit and a retreat position more distant from the fusing unit than the proximity position,
the fusing unit includes an opposing surface that is opposite to a portion of the heating unit and is formed in the first direction,
the heating unit includes
   an adhesion surface that is opposite to the opposing surface and is formed in the first direction, and
   an elastic seal member that is arranged with the first direction as the longitudinal direction, is adhered to the adhesion surface, and is sandwiched between the opposing surface and the adhesion surface when the heating unit is located at the proximity position, and
the seal member has a structure in which a first foam member adhered to the adhesion surface, a resin sheet adhered to the first foam member, and a second foam member adhered to the resin sheet are stacked.

### <Note 2>

The image forming apparatus according to Note 1, in which
the first foam member is constituted by a plurality of unit foam members that is each arranged with the first direction as the longitudinal direction and is arranged with a distance therebetween in the first direction, and
the heating unit has one or more protrusions arranged protruding between the plurality of unit foam members on the adhesion surface.

### <Note 3>

The image forming apparatus according to Note 1 or 2, in which the resin sheet is a polycarbonate sheet member.

### <Note 4>

The image forming apparatus according to any one of Notes 1 to 3, in which
the heating unit includes a ventilation duct including
   an inlet opening that is arranged at a position opposite to a fan,
   a cavity part that is in communication with the inlet opening, and
   an outlet opening that is in communication with the cavity part.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a transfer apparatus that transfers a toner image formed on an image carrier onto a sheet;
a fusing apparatus that fuses the toner image to the sheet by heating and pressing the toner image on the sheet; and
a unit moving mechanism that moves a portion of the fusing apparatus, wherein
the fusing apparatus includes
a fusing unit that includes a fusing member to be heated and a pressure member and is arranged with a first direction as a longitudinal direction, the pressure member biasing the sheet with the toner image formed thereon to the fusing member, and
a heating unit that includes a heater that heats the fusing member and is arranged with the first direction as the longitudinal direction, next to the fusing unit in a second direction that intersects with the first direction,
the unit moving mechanism is a mechanism that moves the heating unit between a proximity position along the fusing unit and a retreat position more distant from the fusing unit than the proximity position,
the fusing unit includes an opposing surface that is opposite to a portion of the heating unit and is formed in the first direction,
the heating unit includes
an adhesion surface that is opposite to the opposing surface and is formed in the first direction, and
an elastic seal member that is arranged with the first direction as the longitudinal direction, is adhered to the adhesion surface, and is sandwiched between the opposing surface and the adhesion surface when the heating unit is located at the proximity position, and
the seal member has a structure in which a first foam member adhered to the adhesion surface, a resin sheet adhered to the first foam member, and a second foam member adhered to the resin sheet are stacked.

2. The image forming apparatus according to claim 1, wherein
the first foam member is constituted by a plurality of unit foam members that is each arranged with the first direction as the longitudinal direction and is arranged with a distance therebetween in the first direction, and
the heating unit has one or more protrusions arranged protruding between the plurality of unit foam members on the adhesion surface.

3. The image forming apparatus according to claim 1, wherein
the resin sheet is a polycarbonate sheet member.

4. The image forming apparatus according to claim 1, wherein
the heating unit includes a ventilation duct including
an inlet opening that is arranged at a position opposite to a fan,
a cavity part that is in communication with the inlet opening, and
an outlet opening that is in communication with the cavity part.
